(19) United States
(12) Patent Application Publication
(10) Pub. No.: US 2009/0039855 A1
(43) Pub. Date: Feb. 12, 2009

(54) Scientific method to accurately regulate point of load power distribution using remote sense connection point switchover

(75) Inventors: Christian Andre D'Souza, (US); Christopher Paul Swider, (US)

Correspondence Address: UTSTARCOM, INC., 3800 GOLF ROAD, SUITE 220, ROLLING MEADOWS, IL, 60008, US

(73) Assignee: UTStarcom, Inc.

(21) Appl. No.: 11/890,372

(22) Filed: Aug. 6, 2007

(51) Int. Cl. G05F 1/10

(52) U.S. Cl. 323/285

(57) ABSTRACT

A power regulation system for providing a regulated voltage to a load is provided. The system includes an energy source or a power source and a switching device. The switching device switches a sensing voltage input of the energy source between a voltage input of a power-line controller and a voltage input of the load based on a status input. A method for providing a regulated voltage to a load is also described.

### BACKGROUND

The invention relates generally to the field of power regulation and distribution and more particularly to a technique for sensing output regulation.

Remote sensing on power supplies or converters generally requires reading the voltage across the output of the power supply and a desired point of load. However, this may not be suitable when a power-line controller, such as a hot-swap or soft-start controller or an electronic circuit breaker (ECB), is used. This is because such devices are designed to cut out the main power supply feed from the load, or to delay the connection until the main power supply stabilizes.

Attempts have been made to connect the remote sensing terminals prior to the power-line controller. However, the major disadvantage with such an approach is that the remote sense terminals are not truly connected to the point of load. Therefore, the voltage regulation does not compensate properly for any resistive voltage drops at the interconnect locations (cables, connectors, circuit board etch or power planes) between the power-line controller and the true point of load. This may result in the power supply margin for the load circuit being compromised or unduly diminished, depending on the design of the product, the distance from the main power supply, and/or the current requirements. Moreover, the circuitry may require over-design and become expensive because of a need to use additional components or components with narrow tolerance specifications, thereby affecting possible supplier base and increasing manufacturing lead-time.

Furthermore, use of the devices in harsh environments with possible temperature extremes further deteriorates the problem. The parasitic DC resistance of cabling and PCB planes is directly proportional to temperature increase. At lower temperatures, voltage at the load can exceed the maximum voltage specification of the electronic device. Similarly, at excessively high temperatures, the voltage at the load may drop below the minimum voltage specification of the electronic device causing erratic operation. Inconsistencies in operation of the power distribution systems due to the product being built at different manufacturing facilities and/or using components sourced from different vendors may result in severe performance issues with the products.

Another attempt has been made to connect the remote sense terminals at the load circuit. However, this presents a situation where the power supply is initially open loop since on power-up the power-line controller is normally open. This disconnects the power supply output and the remote sense node causing the power supply initially to not meet output regulation tolerance or even worse to become unstable. This may further lead to a ramp-up beyond the required voltage output while attempting to reach a valid set-point threshold, exceeding the maximum voltage tolerance of the electronic devices or circuitry connected to the power rail, reducing product reliability, and, inducing component failure.

Therefore, there exists a need for a technique for efficient power regulation in systems with power-line controllers. A need also exists for such a technique that is relatively easy to implement in a cost-effective manner.

### SUMMARY

According to one aspect of the present technique, a power regulating system for providing a regulated voltage to a load is provided. The system includes an energy (power) source and a switching device. The switching device switches a sensing voltage input of the energy source between a voltage input of a power-line controller and a voltage input of the load based on a status signal. A method for providing a regulated voltage to a load is also described.

### BRIEF DESCRIPTION OF THE DRAWINGS

These and other features, aspects, and advantages of the present invention will become apparent when the following detailed description is read with reference to the accompanying drawings in which like characters represent like parts throughout the drawings, wherein:

FIG. 1 is a schematic diagram of an exemplary power system, in accordance with aspects of the present technique;

FIG. 2 is a schematic diagram of the power system of FIG. 1 illustrating single-ended remote sensing technique, in accordance with aspects of the present technique; and

FIG. 3 is a schematic diagram of the power system of FIG. 1 illustrating differential remote sensing technique, in accordance with aspects of the present technique.

### DETAILED DESCRIPTION OF EXEMPLARY EMBODIMENTS

In the subsequent paragraphs, an approach for regulating voltage at a load at higher accuracy via remote sensing mechanism will be explained in detail. The approach described hereinafter describes a technique for accurately sensing the voltage provided to the load and thereby regulating the voltage at the desired level. This is performed by switching a remote sense terminal of a power supply from the voltage input at a power-line controller to the voltage input at the load, or vice versa, so that the power supply receives an accurate measurement of the voltage being delivered to the load. Thus, the regulation of voltage can be performed at higher accuracy. As will be appreciated by those of ordinary skill in the art, the technique is applicable to various systems that utilize a power supply when used in conjunction with a power-line controller for regulation of the line-voltage. Indeed, the exemplary uses and implementations described herein are merely provided as examples to facilitate understanding of the presently contemplated techniques. Therefore, the various aspects of the present technique will be explained, by way of example only, with the aid of figures hereinafter.

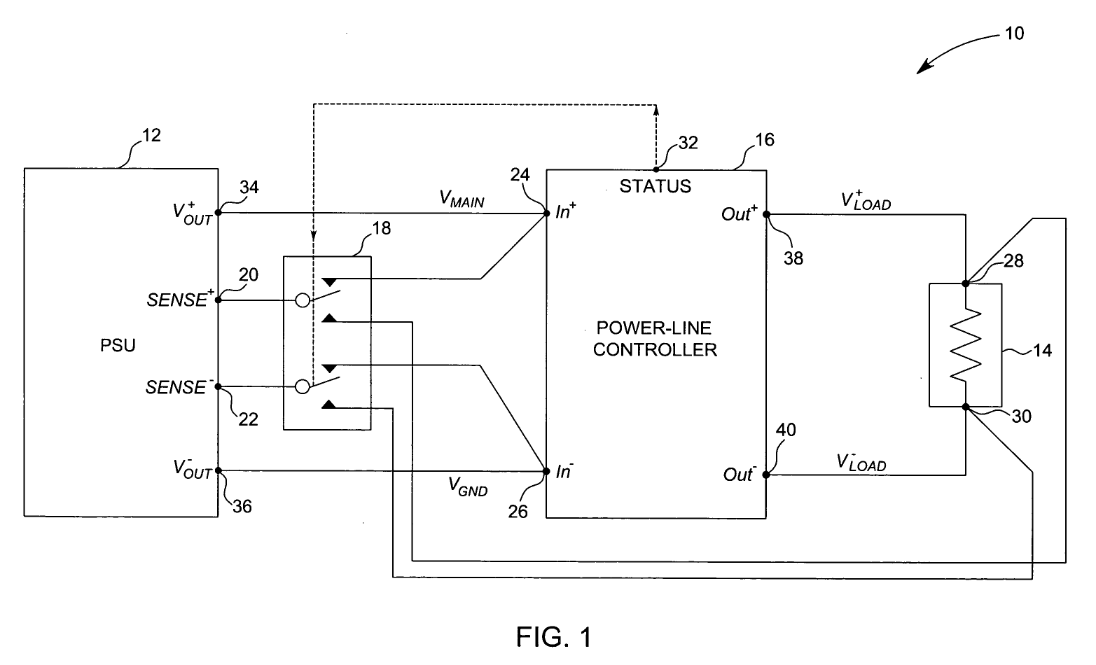

Referring generally to FIG. 1, the voltage regulation mechanism will be described by reference to an exemplary power system designated generally by numeral 10. It should be appreciated however, that the power system 10 may find application in a range of settings and systems, and that its use in voltage regulation described herein is but one such application. As will be explained in detail, the power system 10 is applicable to single board electronic circuits or complex multi-board systems, all of which have in common, means for switching remote sense connection point.

The power system 10 includes a power supply unit 12 coupled to a load 14, as shown. The power supply unit 12 in various embodiments includes: a power regulation arrangement including a switching-mode voltage regulator, a linear voltage regulator, a battery system, an array of dry cells, a lead-acid battery, a lithium-ion battery, a fuel cell, and the like. The power system 10 also comprises a power-line controller 16 that is coupled to the power supply unit 12. The power-line controller 16 includes a hot-swap controller, a soft-start controller, a delay controller, an electronic circuit breaker (ECB), or the like. A switch 18 is coupled to the power supply unit 12 at remote sense terminals SENSE⁺ 20 and SENSE⁻ 22 and facilitates switching the remote sense terminals between voltage input terminals In⁺ 24 and In⁻ 26 of the power-line controller 16 and voltage input terminals 28 and 30 of the load 14. The switch 18, which in one embodiment includes a transistor, may include an analog or a digital switch, such as but not limited to multiplexers, N-type or P-type signal field-effect transistors (FETs), power FETs, linear regulators, power transistors, integrated circuit analog switches, analog cross-bar switches, normally open or normally closed mechanical relays, etc. It is controlled by a signal from status output 32 provided by the power-line controller 16, in one embodiment, such as via a power-good status. However, in other implementations, the signal from status output 32 may be provided externally by an external voltage monitoring circuitry, such as a power sequencing logic circuit. Thus, the signal from status output 32, which is fed as input to the switch 18, indicates that the magnitude of V_{LOAD}⁺ at terminal 28 and V_{LOAD}⁻ at terminal 30 are within the coarse tolerance limits of the expected voltage range required by the load 14.

In the power system 10, the voltage terminals V_{OUT}⁺ 34 and V_{OUT}⁻ 36 of the power supply 12 deliver voltages V_{MAIN} at In⁺ 24 and V_{GND} at In⁻ 26, respectively, where V_{MAIN}=V_{OUT}⁺ and V_{GND}=V_{OUT}⁻ or zero (grounded) as the case may be. Through the power-line controller 16, power is finally delivered to the load 14 from terminals Out⁺ 38 and Out⁻ 40 as V_{LOAD}⁺ at terminal 28 and V_{LOAD}⁻ at terminal 30, where V_{LOAD}⁻=V_{GND} in certain embodiments. The remote sense terminals SENSE⁺ 20 and SENSE⁻ 22 provide remote sense input to the power supply unit 12 for sensing and regulating voltage at the load 14. It is therefore desirable for the remote sense input to closely represent the actual voltage provided to the load 14. The power-line controller 16 couples the load 14 to the power supply unit 12 once the voltage provided by the power supply unit generates the voltage required by the load 14. For adequate power regulation, the remote sense terminals SENSE⁺ 20 and SENSE⁻ 22 are initially coupled to the power-line controller 16 at In⁺ 24 and In⁻ 26, during power-up, by the switch 18. However, when the voltage provided by the power supply unit 12 reaches the voltage required by the load 14 within desired tolerance levels, for example of about ±100 millivolts, switch 18 couples the remote sense terminals SENSE⁺ 20 and SENSE⁻ 22 to the voltage input terminals 28 and 30 of the load. Therefore, the remote sense terminals SENSE⁺ and SENSE⁻ receive the voltage provided to the load 14 with high accuracy. The tolerance ranges acceptable by the load 14 are, however, design-specific and may vary based on the system design.

It may be noted that the switch 18 is controlled via the signal from status output 32 of the power-line controller 16 or by an output signal from an external voltage monitor circuit based on the voltage provided by the power supply 12 to the load 14. Therefore, the power-line controller 16 drives the switch 18, and thus the power-line controller is enabled before the switch can begin its operation. When this voltage reaches the desired tolerance level of the load 14 for a preferred duration, or in other words, the voltage achieves stability, the status output 32 sends a signal to the switch 18 for shifting connection of the remote sense terminals 20 and 22 from the voltage input terminals 24 and 26 to the voltage input terminals 28 and 30 of the load 14. Similarly, when voltage at the voltage input terminals 28 and 30 of the load 14 goes above or below the voltage requirement of the load, the status output 32 again sends a signal to switch the remote sense terminals back from the voltage input terminals 28 and 30 to the voltage input terminals 24 and 26. Moreover, in this condition, the power-line controller 16 disconnects load 14 from the power supply 12. For example, in an over-voltage or an over-current condition, the power-line controller 16 disconnects load 14 from the power supply 12 to prevent the power supply from malfunctioning, shutting down, or getting damaged. Thus, the power supply unit 12 accurately senses the voltage level that is being provided by it and thereby regulates the voltage output better.

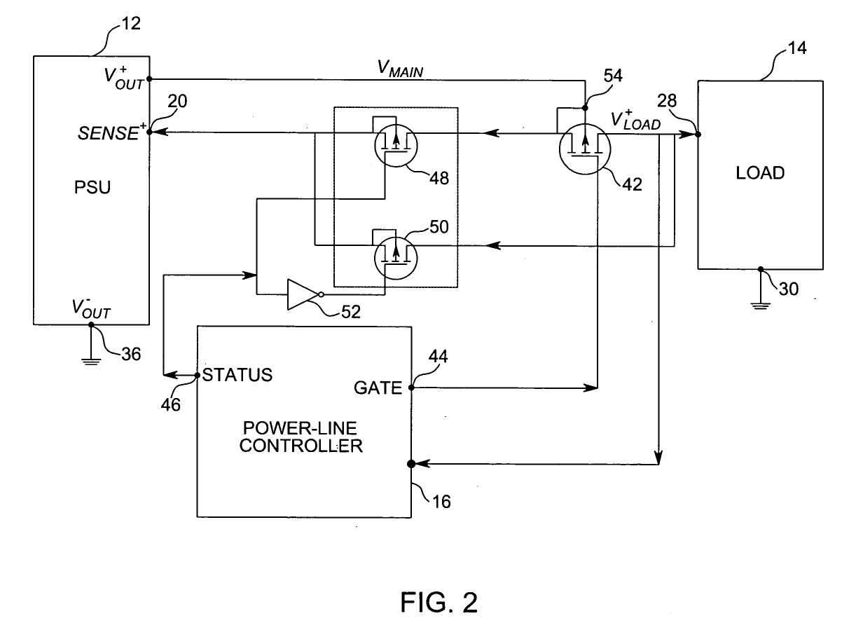

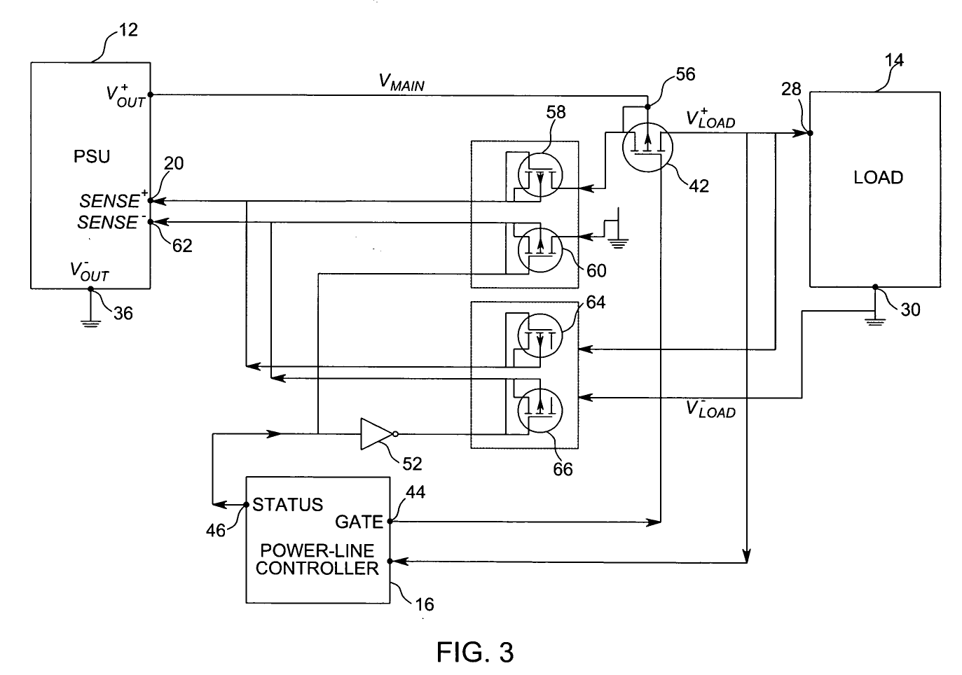

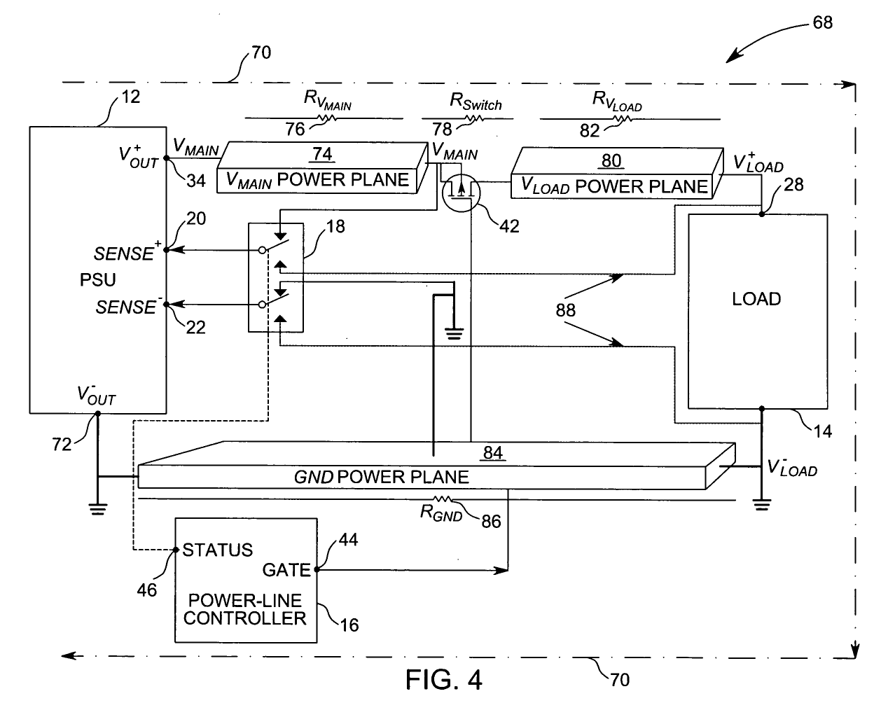

The voltage compensation technique described hereinabove may utilize either a single-ended remote sense mechanism or a differential remote sense mechanism depending on whether the power supply unit 12 or the power-line controller 16 support differential remote sensing. Differential remote sense mechanism provides accurate readings for the voltage drop due to the DC losses in the power plane interconnect as well as the voltage drop associated with the DC losses in the ground plane. The two remote sense schemes will be described below in greater detail with reference to FIG. 2 and FIG. 3.

In one embodiment, the voltage compensation mechanism in the power system of FIG. 1 is implemented using a single-ended sense technique. FIG. 2 is a schematic diagram of the power system of FIG. 1 in one such implementation, using single-ended remote sensing technique. The embodiment includes a power supply unit 12 and a load 14 coupled with a power-line controller 16. The connection of the power supply unit 12 with the load 14 is through a power switch 42, which is a power MOSFET in this embodiment. The power switch 42 is driven by the gate drive signal from a gate terminal 44 of the power-line controller 16. The power-line controller 16 also generates a sense control signal from a status terminal 46 for controlling switches 48 and 50.

When the system is powered ON by the power supply unit 12, the power-line controller 16 is programmed such that the gate terminal 44 generates a LOW gate drive signal (or 0) and the status terminal 46 generates a HIGH sense control signal (or 1). With the gate drive signal being LOW, the power switch 42 is turned OFF and the load 14 is not supplied by the voltage from the power supply unit 12. At the same time, FET 48 is turned ON and FET 50 is turned OFF because of NOT gate 52. Thus, V_{MAIN} from the power supply unit 12 at junction 54 is connected with the SENSE⁺ terminal 20. This ensures that during power-up, the voltage delivered at SENSE⁺ is V_{MAIN}. Once the voltage delivered, as sensed by the In⁺ terminal (not shown) of the power-line controller 16, reaches the amount required by the load 14 (for instance, a pre-determined level based on the system design), the power-line controller 16 switches the gate drive signal HIGH. This results in power switch 42 being turned ON, thereby providing the load 14 with V_{LOAD}=V_{MAIN} at terminal 28. When the voltage V_{LOAD} at terminal 28 is within the coarse tolerance of the load 14, depending on the design specifications, the sense control signal at status terminal 46 is driven LOW. FET 48 is turned OFF, disconnecting the SENSE⁺ terminal 20 from being fed with V_{MAIN}, and FET 50 is turned ON so that SENSE⁺ terminal 20 is provided with V_{LOAD}. If V_{LOAD} dips below the coarse tolerance level of power required by the load 14, the power-line controller 16 disconnects the load from the power supply unit 12 and feeds the SENSE⁺ terminal 20 with V_{MAIN}.

Turning now to FIG. 3, a schematic diagram of the power system of FIG. 1 implemented using differential remote sensing technique is illustrated. When the system is powered ON, the gate drive signal at gate terminal 44 is LOW and status terminal 46 generates a HIGH sense control signal. Because the gate drive signal is LOW, power switch 42 is turned OFF and hence the load 14 is not fed with V_{MAIN} from junction 56. At the same time, the sense control signal at status terminal 46 is HIGH, causing FETs 58 and 60 to be ON, thus providing V_{MAIN} at SENSE⁺ terminal 20 and V_{GND} at SENSE⁻ terminal 62. However, FETs 64 and 66 are driven OFF.

When the voltage delivered, as sensed by the In⁺ terminal (not shown) of the power-line controller 16, reaches the amount required by the load 14 (for example, pre-determined levels depending on system design), the power-line controller 16 generates a HIGH gate drive signal at the gate terminal 44. The HIGH gate drive signal turns ON the power switch 42, therefore connecting the load 14 with the power supply unit 12, i.e., V_{LOAD}=V_{MAIN} at terminal 28. When the voltage V_{LOAD} at terminal 28 is within the coarse tolerance of the load 14, depending on the design specifications, the sense control signal at status terminal 46 is driven LOW. The LOW sense control signal turns OFF the FETs 58 and 60 and turns FETs 64 and 66 ON. With FET 64 being ON, V_{LOAD} is provided at SENSE⁺ terminal 20 and V_{GND} at SENSE⁻ terminal 62. At this stage, if V_{LOAD} dips below the coarse tolerance level of power required by the load 14, the power-line controller 16 disconnects the load from the power supply unit 12 and feeds the SENSE⁺ terminal 20 with V_{MAIN}. This differential sense technique improves regulation of the voltage at the load with even better accuracy compared to the single-ended technique described above with reference to FIG. 2.

The load 14 in all embodiments includes various circuitries, such as a CPU, an ASIC (application specific integrated circuit), logic gates, high-current DC or AC output power supplies or converters with remote sensing capabilities, among others. The power system 10 is furthermore applicable with power supply used to provide power to an electronic subsystem through cable assembly, where the cable assembly feeds the remote sense signals to the main power supply. Other applications for the voltage compensation techniques described hereinabove include: hot-swap control of plug-in or swappable cards and modules where the voltage compensation techniques switch to remote sensing of the cards and modules when local power is determined to be stable, and, switched control of power to ASICs and electronic sub-systems having multiple power-rails. These systems have complex power sequencing schemes and arrangements for preventing component damage. In such applications, power controllers to the ASIC are cut out via a power switch or an ECB. The power system regulates the set-point to the local voltage detected at the primary side of the power switch. When all power supply units are stable at their set-points, then the multiplexer switches to compensate the power at the load while simultaneously enabling all the power switches (or FETs).

Thus, the described method, for providing a regulated voltage to a load, accounts for all component and DC parasitic losses inherent to non-ideal design. For example, with reference to FIG. 4, power system 68 illustrates the various parasitic losses, as described below. The power system 68 shows the direction of current flow generally by reference numeral 70. The current flows from the voltage terminal V_{OUT}⁺ 34 towards V_{OUT}⁻ 72 of power supply unit 12 through the power switch 42 and load 14. The V_{MAIN} power plane 74 between V_{OUT}⁺ 34 and power switch 42 offers parasitic resistance R_{V}_{_{MAIN}} 76. The power switch 42 offers parasitic resistance R_{Switch} 78, while V_{LOAD} power plane 80 between power switch 42 and voltage input terminal 28 of load 14 offers parasitic resistance R_{V}_{_{LOAD}} 82. Furthermore, the GND power plane 84 offers a parasitic resistance R_{GND} 86. Therefore, the actual voltage drop across the load 14 is given by:

V_{Drop}=I×(R_{V}_{_{MAIN}}+R_{Switch}+R_{V}_{_{LOAD}}+R_{GND});

where, I is the current flow and V_{Drop} is the voltage drop across the load 14. Together, these potentially high-loss and highly variable parasitic resistances in the power delivery interconnect planes are compensated for by the low-loss/low-current remote sense connection switching. The remote sense connecting lines are generally shown by reference numeral 88.

While only certain aspects of the invention have been illustrated and described herein, many modifications and changes will occur to those skilled in the art. It is, therefore, to be understood that the appended claims are intended to cover all such modifications and changes that fall within the true spirit of the invention.

1. A power regulating system for providing a regulated voltage to a load, the system comprising:
an energy source; and
a switching device that switches a sensing voltage input of the energy source between a voltage input of a power-line controller and a voltage input of the load based on a status signal.

2. The system of claim 1, wherein the switching device couples the sensing voltage input to the voltage input of the load when the energy source is coupled to the load.

3. The system of claim 1, wherein the switching device comprises an analog switching device.

4. The system of claim 1, wherein the switching device comprises a digital switching device.

5. The system of claim 1, wherein the power-line controller comprises a circuit breaker.

6. The system of claim 1, wherein the power-line controller comprises a hot-swap controller.

7. The system of claim 1, wherein the status signal is generated by the power-line controller.

8. The system of claim 1, wherein the status signal is generated by an external monitor.

9. The system of claim 1, wherein the status signal is indicative of a degree of voltage stability.

10. A method for providing a regulated voltage to a load, the method comprising:
regulating power from an energy source; and
providing a status signal to a switching device for switching a sensing voltage input of the energy source between a voltage input of a power-line controller and a voltage input of the load.

11. The method of claim 10, wherein switching the sensing voltage input comprises coupling the sensing voltage input to the voltage input of the load when the energy source is coupled to the load.

12. The method of claim 10, wherein switching the sensing voltage input comprises switching via a single-ended sensing voltage input.

13. The method of claim 10, wherein switching the sensing voltage input comprises switching via a differential sensing voltage input.

14. The method of claim 10, comprising generating the status signal based on a degree of voltage stability.

15. The method of claim 10, wherein generating the status signal comprises generating the status signal externally.

16. The method of claim 10, wherein generating the status signal comprises generating the status signal via the power-line controller.

17. A power supply system, comprising:
an energy source providing a regulated voltage to a load; and
a switching device that switches a sensing voltage input of the energy source between a voltage input of a power-line controller and a voltage input of the load based on a status signal.

18. The system of claim 17, wherein the switching device couples the sensing voltage input to the voltage input of the load when the energy source is coupled to the load.

19. The system of claim 17, wherein the status signal is generated by the power-line controller.

20. The system of claim 17, wherein the status signal is generated externally.

21. The system of claim 17, wherein the status signal is indicative of a degree of voltage stability.
